(19) United States
(12) Patent Application Publication
(10) Pub. No.: US 2026/0200420 A1
(43) Pub. Date: Jul. 16, 2026

(54) POWER SUPPLY CONTROL DEVICE AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuta TANINAKA, Yokkaichi-shi, Mie (JP); Kota ODA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/133,910

(22) PCT Filed: Nov. 20, 2023
(86) PCT No.: PCT/JP2023/041559

§ 371 Date: May 29, 2025

(30) Foreign Application Priority Data
Nov. 30, 2022 (JP) 2022-191572

(51) Int. Cl. B60R 16/03; B60R 16/023

(52) U.S. Cl. CPC B60R 16/03; B60R 16/023

(57) ABSTRACT

A vehicle power supply control device that controls power supply to an in-vehicle device, including: a switch configured to turn on and off power supply to the in-vehicle device; and a control unit configured to acquire new device information pertaining to a new in-vehicle device that is newly connected, from the new in-vehicle device, and to perform opening and closing control on the switch in accordance with the acquired new device information.

### CROSS-REFERENCE TO RELATED APPLICATIONS

This application is the U.S. national stage of PCT/JP2023/041559 filed on Nov. 20, 2023, which claims priority of Japanese Patent Application No. JP 2022-191572 filed on Nov. 30, 2022, the contents of which are incorporated herein.

### TECHNICAL FIELD

The present disclosure relates to a power supply control device mounted on a vehicle and a computer program.

### BACKGROUND

Conventionally, in a vehicle, a power supply control device is interposed between a power source and in-vehicle devices, and power supply from the power source is distributed to each of the in-vehicle devices.

Meanwhile, JP 2019-38344A discloses a load controller interposed between a power source and loads, in which a line from the power source is branched into a plurality of lines and the loads are connected to the loads via the branched lines as necessary.

### SUMMARY

A power supply control device according to one embodiment of the present disclosure is a vehicle power supply control device that controls power supply to an in-vehicle device, including: a switch configured to turn on and off power supply to the in-vehicle device; and a control unit configured to acquire new device information pertaining to a new in-vehicle device that is newly connected, from the new in-vehicle device, and to perform opening and closing control on the switch in accordance with the acquired new device information.

A computer program according to an embodiment of the present disclosure enables a computer for a vehicle power supply control device that controls power supply to an in-vehicle device, to perform processing to: acquire new device information pertaining to a new in-vehicle device that is newly connected, from the new in-vehicle device; and perform opening and closing control on a switch to turn on and off power supply to the new in-vehicle device in accordance with the acquired new device information.

When an in-vehicle device is connected to a power supply control device, malfunction or damage may occur if an overcurrent equal to or greater than a threshold value flows. In addition, for example, since the activation time is different for each in-vehicle device, it is necessary to supply power from the power supply control device appropriately in accordance with the specifications of the in-vehicle device that is connected.

However, when a new in-vehicle device is connected to the power supply control device, if the specifications of the new in-vehicle device are unknown, the power supply control device cannot handle it appropriately

That is, an overcurrent equal to or greater than the threshold value may flow from the power supply control device to the new in-vehicle device because the threshold value of a current allowed for the new in-vehicle device is unknown, or the new in-vehicle device may fail to activate at the appropriate time and be unable to function as intended.

However, JP 2019-38344A does not consider such a problem, and cannot solve the problem.

Therefore, one object is to provide a power supply control device and a computer program that can appropriately handle a newly added or replaced in-vehicle device.

### Advantageous Effects

According to the present disclosure, it is possible to provide a power supply control device and a computer program that can appropriately handle a newly added or replaced in-vehicle device.

### BRIEF DESCRIPTION OF DRAWINGS

FIG. 1 is a functional block diagram showing a configuration of a main part of a vehicle in which a power supply control device according to a first embodiment is mounted.

FIG. 2 is a flowchart illustrating switch opening and closing control performed by the power supply control device according to the first embodiment.

FIG. 3 is a functional block diagram showing a configuration of a main part of a vehicle in which a power supply control device according to a second embodiment is mounted.

FIG. 4 is a flowchart illustrating switch opening and closing control performed by the power supply control device according to the second embodiment.

### DETAILED DESCRIPTION OF PREFERRED EMBODIMENTS

First, embodiments of the present disclosure will be listed and described. At least part of the embodiments described below may be combined as desired.

In a first aspect, a power supply control device according to one embodiment of the present disclosure is a vehicle power supply control device that controls power supply to an in vehicle device, including: a switch configured to turn on and off power supply to the in-vehicle device; and a control unit configured to acquire new device information pertaining to a new in vehicle device that is newly connected, from the new in-vehicle device, and to perform opening and closing control on the switch in accordance with the acquired new device information.

In this embodiment, when a new in-vehicle device is newly connected to the power supply control device, the control unit acquires new device information pertaining to the new in-vehicle device that is newly connected, from the new in-vehicle device, and performs the opening and closing control on the switch in accordance with the acquired new device information to turn on and off power supply to the new in-vehicle device. Therefore, it is possible to supply power appropriately for the newly added or replaced in-vehicle device.

In a second aspect, in the power supply control device according to an embodiment of the present disclosure, the control unit acquires the new device information when power is first supplied to the new in-vehicle device.

In this embodiment, when power is firstly supplied to the new in-vehicle device, the control unit acquires new device information pertaining to the new in-vehicle device that is newly connected, from the new in-vehicle device, and performs the opening and closing control of the switch in accordance with the acquired new device information to turn on and off supply power to the new in-vehicle device. Therefore, it is possible to supply power appropriately for the newly added or replaced in-vehicle device.

In a third aspect, in the power supply control device according to an embodiment of the present disclosure, the control unit performs the opening and closing control in accordance with basic information stored in advance in a storage unit, and when the new device information is acquired from the new in-vehicle device, the control unit changes the basic information in accordance with the acquired new device information.

In this embodiment, when the new in-vehicle device is newly connected to the power supply control device, the opening and closing control is performed in accordance with the basic information stored in the storage unit in advance, and when the new device information is acquired from the new in-vehicle device, the basic information is changed in accordance with the acquired new device information, and the opening and closing control is performed in accordance with the changed basic information. Therefore, it is possible to supply power appropriately for the newly added or replaced in-vehicle device.

In a fourth aspect, in the power supply control device according to an embodiment of the present disclosure, the new device information contains information pertaining to an opening and closing timing of a switch of the new in-vehicle device that turns on and off connection to the power supply control device.

In this embodiment, when the new in-vehicle device is newly connected to the power supply control device, the control unit acquires the information pertaining to the opening and closing timing, from the new in-vehicle device, and performs the opening and closing control on the switch in accordance with the acquired information pertaining to the opening and closing timing to turn on and off power supply to the new in-vehicle device. Therefore, it is possible to supply power appropriately for the newly added or replaced in-vehicle device.

In a fifth aspect, in the power supply control device according to an embodiment of the present disclosure, the new device information contains information pertaining to a current consumption value or a dark current value of the new in-vehicle device.

In this embodiment, when the new in-vehicle device is newly connected to the power supply control device, the control unit acquires the information pertaining to the current consumption value or the dark current value, from the new in vehicle device, and performs the opening and closing control on the switch in accordance with the acquired information pertaining to the current consumption value or the dark current value to turn on and off power supply to the new in-vehicle device. Therefore, it is possible to supply power appropriately for the newly added or replaced in-vehicle device.

In a sixth aspect, in the power supply control device according to an embodiment of the present disclosure, the new device information contains information pertaining to an activation time or a deactivation time of the new in-vehicle device.

In this embodiment, when the new in-vehicle device is newly connected to the power supply control device, the control unit acquires the information pertaining to the activation time or the deactivation time, from the new in-vehicle device, and performs the opening and closing control on the switch in accordance with the acquired information pertaining to the activation time or the deactivation time to turn on and off power supply to the new in-vehicle device. Therefore, it is possible to supply power appropriately for the newly added or replaced in vehicle device.

In a seventh aspect, a computer program according to an embodiment of the present disclosure enables a computer for a vehicle power supply control device that controls power supply control to an in-vehicle device, to perform processing to: acquire new device information pertaining to a new in-vehicle device that is newly connected, from the new in-vehicle device; and perform opening and closing control on a switch to turn on and off power supply to the new in vehicle device in accordance with the acquired new device information.

In this embodiment, when the new in-vehicle device is newly connected to the power supply control device, new device information pertaining to the new in-vehicle device that is newly connected, is acquired from the new in-vehicle device, and the opening and closing control of the switch is performed in accordance with the acquired new device information. Therefore, power supply can be performed appropriately for the newly added or replaced in-vehicle device.

A power supply control device and a computer program according to embodiments of the present disclosure will be described below with reference to the drawings. It should be noted that the present disclosure is not limited to the following examples, but is intended to encompass all variations and modifications indicated by, equivalent to, and falling within the meaning and range of the appended claims.

### First Embodiment

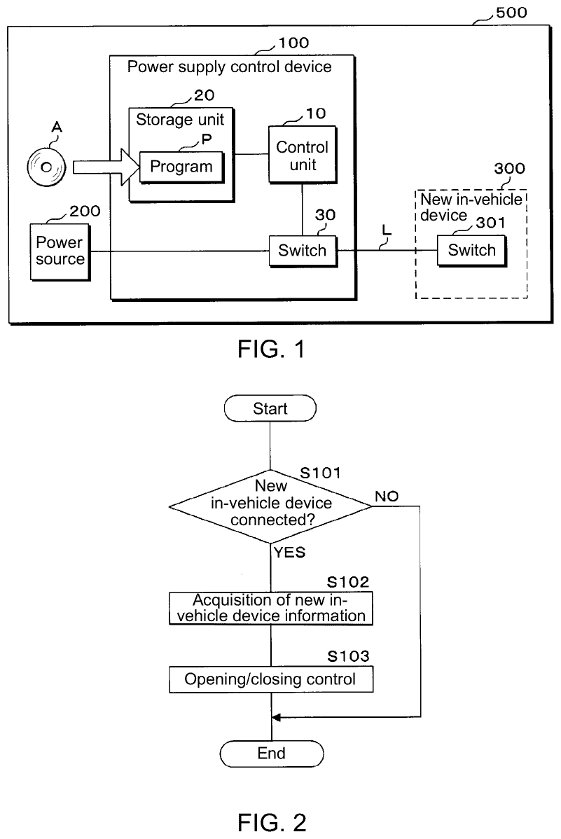

FIG. 1 is a functional block diagram showing a configuration of a main part of a vehicle 500 in which a power supply control device 100 according to a first embodiment is mounted. The vehicle 500 includes the power supply control device 100 and a power source 200.

The power source 200 is, for example, a battery, and a new in-vehicle device 300 described above is connected to the power supply control device 100. The new in vehicle device 300 is, for example, an electrical device such as a room lamp or a drive recorder. As shown in FIG. 1, the power supply control device 100 is interposed between the power source 200 and the new in-vehicle device 300, and controls power supply from the power source 200 to the new in-vehicle device 300.

For example, the power supply control device 100 according to the first embodiment includes an output terminal (not shown), and a power wiring L is connected to the output terminal. The new in-vehicle device 300 is connected to the power supply control device 100 via the power wiring L.

Electric power input from the power source 200 to the power supply control device 100 is supplied to the new in-vehicle device 300 via the power wiring L. At this time, the power supply control device 100 controls the power supply to the new in vehicle device 300.

FIG. 1 shows a case where the power wiring L is an available power wiring, and the new in vehicle device 300 is newly connected to the power wiring L. In FIG. 1, the new in-vehicle device 300 is indicated by dotted lines for convenience.

In the following, a case where the new in-vehicle device 300 is newly connected to the power wiring L, which is the available power wiring, will be described as one example, but the present disclosure is not limited to this. An in-vehicle device already connected to the power wiring L may be replaced with the new in-vehicle device 300.

The power supply control device 100 includes a storage unit 20, a control unit 10, and a switch 30.

The switch 30 is interposed between the power source 200 and the new in-vehicle device 300. That is, the power wiring from the power source 200 is connected to the switch 30, and as described above, the switch 30 is connected to the new in-vehicle device 300 via the power wiring L. The control unit 10 controls power supply to the new in-vehicle device 300 by controlling the opening and closing of the switch 30.

The storage unit 20 is constituted by a volatile memory element such as a RAM (Random Access Memory) or a non-volatile memory element such as a ROM (Read Only Memory), an EEPROM (Electrically Erasable Programmable ROM), and a flash memory. A control program P and data to be referenced during processing have been stored in advance in the storage unit 20. The storage unit 20 also stores a reference table. In the reference table, an electric signal, which will be described later, and a shutoff threshold value, which serves as new device information, are associated with each other.

The control program P stored in the storage unit 20 may be a control program P read out from a readable recording medium A and stored by the control unit 10. The control program P stored in the storage unit 20 may be a program downloaded from an external device (not shown) connected to a communication network (not shown) and stored in the storage unit 20 by the control unit 10.

The control unit 10 is constituted by an arithmetic processing unit such as a CPU (Central Processing Unit), or an MPU (Micro Processing Unit). The control unit 10 performs various types of control processing and arithmetic processing by reading out and executing a control program P and data stored in advance in the storage unit 20. The control unit 10 is connected to the switch 30 via an internal bus and a plurality of signal lines, and performs opening and closing control to open or close the switch 30.

The switch 30 is a semiconductor switch configured as an IPD (Intelligent Power Device), for example. The switch 30 is configured as an IPD (Intelligent Power Device) including, for example, a FET (Field effect transistor) or an IGBT (Insulated Gate Bipolar Transistor). The switch 30 turns on and off power supply to the new in-vehicle device 300 via the power wiring L. The switch 30 also functions as a current detecting unit.

The control unit 10 outputs (applies) a gate signal (PWM control signal) to the gate terminal of the switch 30 to open and close the switch 30, thereby performing PWM control. That is, the switch 30 is opened or closed in response to the PWM control signal input from the control unit 10, and a pulse voltage (electric power) is output to the new in-vehicle device 300 in response to this.

Such opening/closing of the switch 30 is controlled in accordance with the specifications of the new in vehicle device 300 that is newly connected.

For example, the control unit 10 achieves the function of shutting off an overcurrent from flowing to the new in-vehicle device 300 by controlling the opening/closing of the switch 30 in accordance with the new in-vehicle device 300. Specifically, the switch 30 is set based on a threshold value (hereinafter referred to as a shutoff threshold value) used for overcurrent shutoff, which is determined in accordance with the new in-vehicle device 300, and the control unit 10 opens the switch 30 when a current exceeding this shutoff threshold value flows through the switch 30.

More specifically, if a malfunction or damage may occur when a current greater than 10A flows in the new in-vehicle device 300, the shutoff threshold value pertaining to the new in-vehicle device 300 is 10A. Therefore, when a current greater than 10A (shutoff threshold value) flows through the switch 30, the control unit 10 opens the switch 30 to shut off the flow of an overcurrent exceeding the shutoff threshold value in the new in-vehicle device 300.

It it possible to consider a case where a new in vehicle device 300 is connected to the power supply control device 100, that is, another new in-vehicle device 300 is connected to the available power wiring L or the already connected in-vehicle device is replaced with a new in-vehicle device 300.

Here, when a new in vehicle device 300 is newly connected, the power supply control device 100 may not be able to appropriately handle the new in vehicle device 300 because the specifications of the new in-vehicle device 300 are unknown.

For example, when a new in-vehicle device 300 is newly connected, the shutoff threshold value pertaining to the new in-vehicle device 300 is unknown, and the control unit 10 cannot appropriately perform the opening and closing control on the switch 30. Therefore, there is a concern that the overcurrent exceeding the shutoff threshold value may flow in the new in-vehicle device 300.

The power supply control device 100 according to the first embodiment can address such a problem. This will be described below. For convenience, the following description will be given by taking, as one example, a case where the new in-vehicle device 300 is connected to the available power wiring (power wiring L).

FIG. 2 is a flowchart illustrating opening and closing control of the switch 30 performed by the power supply control device 100 according to the first embodiment.

For example, when a signal for turning on an ignition power source output from an IG switch (not shown) of the vehicle 500 is obtained, the control unit 10 determines whether or not a new in vehicle device 300 is connected to the power wiring L (step S101).

For example, the control unit 10 performs the determination by monitoring a current value flowing through the switch 30. If the current value is “0”, the control unit 10 determines that a new in-vehicle device 300 is not connected to the power wiring L (step S101: NO), and ends processing.

If the current value is not “0”, the control unit 10 determines that a new in-vehicle device 300 is connected to the power wiring L (step S101: YES), and acquires in-vehicle device information pertaining to the new in-vehicle device 300, from the new in-vehicle device 300 (step S102). Here, the in-vehicle device information is information indicating the specifications of the new in-vehicle device 300, and contains, for example, a shutoff threshold value of the new in-vehicle device 300. Hereinafter, the in-vehicle device information pertaining to the new in-vehicle device 300 is referred to as new device information.

That is, when power is first supplied to the new in-vehicle device 300 newly connected, the new in-vehicle device 300 transmits an electric signal for specifying new device information pertaining to the new in-vehicle device to the control unit 10 via the power wiring L, and the control unit 10 acquires the new device information based on the electric signal from the new in-vehicle device 300.

More specifically, when power is first supplied, the new in-vehicle device 300 opens or closes a switch 301 included in the new in-vehicle device a predetermined number of times at predetermined intervals to transmit an electric signal. That is, the new in vehicle device 300 transmits the electric signal that specifies the new device information of the new in-vehicle device, which is formed of a combination of the number of times of opening and closing and the opening and closing interval of the switch 301, to the power supply control device 100. The control unit 10 monitors a current flowing through the switch 30 to obtain an electric signal from the new in-vehicle device 300.

The control unit 10 that has obtained the electric signal specifies the shutoff threshold value (new device information) of the new in-vehicle device 300 newly connected, by referring to the reference table in the storage unit 20. Thereafter, the control unit 10 controls the opening/closing of the switch 30 using the specified shutoff threshold value (step S103), and prevents the overcurrent, which exceeds the shutoff threshold value, from flowing to the new in vehicle device 300.

Thus, even when a new in vehicle device 300 whose specifications are unknown is connected to the power supply control device 100 or even when an unexpected new in-vehicle device 300 is connected, the power supply control device 100 can appropriately handle the case. Therefore, the new in-vehicle device 300 can be operated as appropriate regardless of the specifications of the new in-vehicle device 300.

In the above description, the case where the shutoff threshold value is stored as the new device information in the reference table, that is, the case where the new device information is the shutoff threshold value has been described as one example, but the present disclosure is not limited to this. The new device information may be the opening and closing timing of the switch 301 of the new in-vehicle device 300, which turns on and off connection to the power supply control device 100. Specific examples of such an opening and closing timing include opening/closing in conjunction with an ACC relay and opening/closing in conjunction with a door lock.

The new device information may also be a current consumption value or a dark current value of the new in-vehicle device 300. In this case, the power supply control device 100 (control unit 10) controls the opening and closing of the switch 30 based on the residual amount of power in the power source 200, as well as the current consumption value or the dark current value of the new in vehicle device 300.

Furthermore, the new device information may be an activation time or a deactivation time of the new in-vehicle device 300. Here, the activation time is the time from the start of the power supply to the beginning of operation, and the deactivation time is time from the stop of power supply to the end of operation.

### Second Embodiment

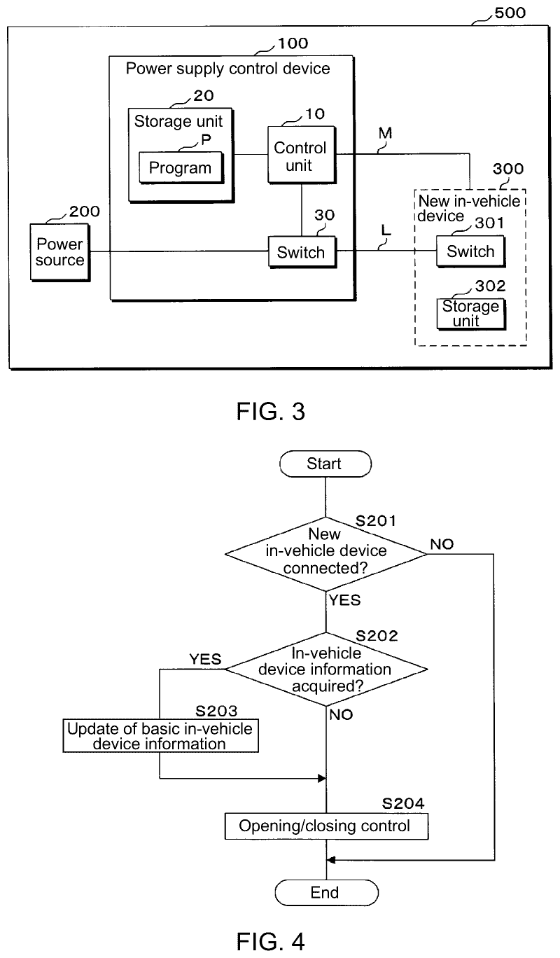

FIG. 3 is a functional block diagram showing a configuration of a main part of a vehicle 500 in which a power supply control device 100 according to a second embodiment is mounted.

The vehicle 500 includes the power supply control device 100 and a power source 200. As in the first embodiment, a new in-vehicle device 300 is connected to the power supply control device 100, and the new in-vehicle device 300 is connected to the power supply control device 100 via a power wiring L. FIG. 3 shows a case where the power wiring L is an available power wiring, and the new in-vehicle device 300 is newly connected to the power wiring L. In FIG. 3, the new in-vehicle device 300 is indicated by dotted lines for convenience.

For example, the power source 200 is a battery, and the new in-vehicle device 300 is an electrical device such as a room lamp or a drive recorder. The power supply control device 100 is interposed between the power source 200 and the new in-vehicle device 300, and controls power supply from the power source 200 to the new in-vehicle device 300.

The power supply control device 100 includes a storage unit 20, a control unit 10, and a switch 30. The switch 30, between the power source 200 and the new in-vehicle device 300, turns on and off the connection to the power source 200 and the new in-vehicle device 300.

As in the first embodiment, a control program P and data to be referenced during processing are stored in advance in the storage unit 20. In the power supply control device 100 according to the second embodiment, the storage unit 20 stores basic in-vehicle device information. The basic in-vehicle device information is in-vehicle device information stored in advance in the storage unit 20 by default. The storage unit 20, the control unit 10, and the switch 30 have been described in the first embodiment, and thus detailed description thereof will be omitted.

The following describes a case where the basic in-vehicle device information stored in the storage unit 20 is a shutoff threshold value as an example. That is, the storage unit 20 stores the shutoff threshold value (hereinafter, referred to as a basic shutoff threshold value) as basic in-vehicle device information in advance.

Furthermore, in the power supply control device 100 according to the second embodiment, the power supply control device 100 and the new in-vehicle device 300 are connected via a communication line M in addition to the power wiring L. That is, the communication line M is connected to the control unit 10 of the power supply control device 100, and the control unit 10 can communicate with the new in-vehicle device 300 newly connected via the communication line M.

FIG. 4 is a flowchart illustrating opening and closing control of the switch 30 performed by the power supply control device 100 according to the second embodiment. For convenience, the following description will be given by taking, as one example, a case where the new in-vehicle device 300 is connected to the available power wiring (power wiring L).

For example, when a signal for turning on an ignition power source is obtained from the IG switch of the vehicle 500, the control unit 10 determines whether or not a new in-vehicle device 300 is connected (step S201).

For example, the control unit 10 performs the determination by monitoring a current value flowing through the switch 30. If the current value is “0”, the control unit 10 determines that a new in-vehicle device 300 is not connected (step S201: NO), and ends processing.

If the current value is not “0”, the control unit 10 determines that a new in-vehicle device 300 is connected (step S201: YES), and determines whether or not new device information pertaining to the new in-vehicle device 300 has been acquired from the new in-vehicle device 300 (step S202). Such determination is made by the control unit 10 monitoring the acquisition of new device information via the communication line M.

As described above, when power is first supplied to the new in-vehicle device 300 newly connected, if the new in-vehicle device 300 transmits the new device information stored in a storage unit 302 of the new in-vehicle device to the control unit 10 via the communication line M, the power supply control device 100 can acquire the new device information pertaining to the new in-vehicle device 300 from the new in-vehicle device 300.

At this time, the control unit 10 determines that the new device information pertaining to the new in-vehicle device 300 has been acquired from the new in-vehicle device 300 (step S202: YES). Next, the control unit 10 updates the basic in-vehicle device information (basic shutoff threshold value) stored in advance in the storage unit 20 in accordance with the new device information received from the new in-vehicle device 300 (step S203).

Thereafter, the control unit 10 controls the opening/closing of the switch 30 using the updated basic in-vehicle device information (step S204), and prevents the overcurrent, which exceeds the shutoff threshold value, from flowing to the new in-vehicle device 300.

On the other hand, if the new in-vehicle device 300 does not have new device information pertaining to the new in-vehicle device, for example, the power supply control device 100 cannot acquire new device information from the new in-vehicle device 300.

At this time, the control unit 10 determines that new device information has not been acquired from the new in-vehicle device 300 (step S202: NO), and processing proceeds to a step S204. In this case, the control unit 10 controls the opening/closing of the switch 30 using the basic in-vehicle device information (basic shutoff threshold value) stored in advance in the storage unit 20, and prevents the overcurrent, which exceeds the shutoff threshold value, from flowing to the new in-vehicle device 300.

Thus, even when the new in-vehicle device 300 whose specifications are unknown is connected to the power supply control device 100 or even when an unexpected new in-vehicle device 300 is connected, the power supply control device 100 can appropriately handle the case.

In the above description, the case where the new device information is the shutoff threshold value has been described as one example, but the present disclosure is not limited to this. The new device information may be an opening and closing timing of the switch 301 of the new in-vehicle device 300, a current consumption value or a dark current value of the new in-vehicle device 300, or an activation time or a deactivation time of the new in-vehicle device 300.

In the above description, the case where the new device information of the new in-vehicle device 300 used for updating the basic in-vehicle device information is transmitted to the power supply control device 100 via the communication line M has been described as an example, but the present disclosure is not limited to this.

As in the first embodiment, the reference table may be stored in the storage unit 20, and the power supply control device 100 may receive an electric signal from the new in-vehicle device 300 and perform the above-described update. That is, the power supply control device 100 (control unit 10) specifies (acquires) new device information with reference to the reference table based on the electric signal from the new in-vehicle device 300, and updates the basic in vehicle device information.

In the above description, the case where the power supply control device 100 (control unit 10) and the new in-vehicle device 300 communicate with each other via the communication line M has been described as an example, but the present disclosure is not limited to this, and they may be configured to perform wireless communication.

The embodiments disclosed herein are intended to be considered in all respects as illustrative and not restrictive. The scope of the disclosure is not limited to the meaning above description, but is intended to encompass all variations and modifications indicated by, equivalent to, and falling within the meaning and range of the appended claims.

The items described in each embodiment can be combined with each other. The independent claims and dependent claims recited in the claims may be combined with each other in any and all combinations, regardless of the form in which they are cited. Further, although the scope of claims uses a format in which claims refer to two or more other claims (multi-claim format), the disclosure is not limited to this format. It may be written using a format that describes multiple claims (multi-multi-claims) that cite at least one multiple claim.

1. A vehicle power supply control device that controls power supply to an in-vehicle device, comprising:
a switch configured to turn on and off power supply to the in-vehicle device; and
a control unit configured to acquire new device information pertaining to a new in-vehicle device that is newly connected, from the new in-vehicle device, and to perform opening and closing control on the switch in accordance with the acquired new device information.

2. The power supply control device according to claim 1, wherein the control unit acquires the new device information when power is first supplied to the new in-vehicle device.

3. The power supply control device according to claim 1,
wherein the control unit performs the opening and closing control in accordance with basic information stored in advance in a storage unit, and
when the new device information is acquired from the new in-vehicle device, the control unit changes the basic information in accordance with the acquired new device information.

4. The power supply control device according to claim 1, wherein the new device information contains information pertaining to an opening and closing timing of a switch of the new in-vehicle device that turns on and off connection to the power supply control device.

5. The power supply control device according to claim 1, wherein the new device information contains information pertaining to a current consumption value or a dark current value of the new in-vehicle device.

6. The power supply control device according to claim 1, wherein the new device information contains information pertaining to an activation time or a deactivation time of the new in-vehicle device.

7. A computer program that enables a computer for a vehicle power supply control device that controls power supply to an in-vehicle device, to perform processing to:
acquire new device information pertaining to a new in-vehicle device that is newly connected, from the new in-vehicle device; and
perform opening and closing control on a switch to turn on and off power supply to the new in-vehicle device in accordance with the acquired new device information.

8. The power supply control device according to claim 2, wherein the new device information contains information pertaining to an opening and closing timing of a switch of the new in-vehicle device that turns on and off connection to the power supply control device.

9. The power supply control device according to claim 3, wherein the new device information contains information pertaining to an opening and closing timing of a switch of the new in-vehicle device that turns on and off connection to the power supply control device.

10. The power supply control device according to claim 2, wherein the new device information contains information pertaining to a current consumption value or a dark current value of the new in-vehicle device.

11. The power supply control device according to claim 3, wherein the new device information contains information pertaining to a current consumption value or a dark current value of the new in-vehicle device.

12. The power supply control device according to claim 2, wherein the new device information contains information pertaining to an activation time or a deactivation time of the new in-vehicle device.

13. The power supply control device according to claim 3, wherein the new device information contains information pertaining to an activation time or a deactivation time of the new in-vehicle device.
